(19) United States
(12) Patent Application Publication
(10) Pub. No.: US 2003/0049059 A1
(43) Pub. Date: Mar. 13, 2003

(54) Removable cartridge-detone skive blade

(75) Inventors: George D. Gross, Rochester, NY (US); Charles D. Odum, Rochester, NY (US)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/080,122

(22) Filed: Feb. 21, 2002

Related U.S. Application Data
(60) Provisional application No. 60/317,396, filed on Sep. 5, 2001.

(51) Int. Cl. G03G 21/00

(52) U.S. Cl. 399/353; 399/357

(57) ABSTRACT

A method and structure for a cleaning a roller in an imaging apparatus includes the steps of providing a cleaner assembly with a skive blade in contact with the roller and forming a slot in a casing of the cleaner assembly. The skive blade can be selectively mounted on and removed from the cleaner assembly.

### BACKGROUND OF THE INVENTION

1. Field of the Invention

The present invention relates in general to a skive assembly for a detone roller, and more particularly to a removable contact skive blade which is easily replaced.

2. Description of the Related Art

In a typical commercial reproduction apparatus (electrostatographic copier/duplicators, printers, or the like), a latent image charge pattern is formed on a uniformly charged dielectric member. Pigmented marking particles are attracted to the latent image charge pattern to develop such images on the dielectric member. A receiver member is then brought into contact with the dielectric member. An electric field, such as provided by a corona charger or an electrically biased roller, is applied to transfer the marking particle developed image to the receiver member from the dielectric member. After transfer, the receiver member bearing the transferred image is separated from the dielectric member and transported away from the dielectric member to a fuser apparatus at a downstream location. There the image is fixed to the receiver member by heat and/or pressure from the fuser apparatus to form a permanent reproduction thereon. However, not all of the marking particles are transferred to the printing material and some remain upon the belts or drum. Therefore, a cleaning assembly is commonly used to remove the excess marketing particles. The cleaning assembly usually includes an electrostatic cleaning brush, a detone roller, a skive, and a receptacle to hold the excess marking particles (waste toner material). The skive is a knife like device that contacts the detone roller as the roller turns to clean the roller. More specifically, the skive contacts the surface of the detone roller and detaches the excess marking particles and other debris and causes such waste products to fall into a container which can then be periodically removed and disposed of or recycled. The cleaning assembly can be provided to the customer and as a sealed container that is replaced as a unit, or provided to the customer as a unit can only be serviced by specially trained personnel, containing little to no customer replaceable parts. Therefore, the conventional cleaning assembly is not customer serviceable and can only be disposed of remanufactured, or serviced on site by specially trained personnel.

One of the devices within the cleaning assembly that experiences wear is the skive. More specifically, the skive blade itself is easily damaged and may wear out before other components of the cleaner assembly. Such a situation increases maintenance costs because when it is detected that the cleaning assembly is not performing its job, the entire assembly must be replaced. Because of the excessive wear experienced by the skive blade, many times the remaining components are operating properly and only the skive blade needs to be replaced. However, because the conventional cleaner assembly does not allow replacement of individual components, it is not possible to replace only the skive blade. Therefore, there is a need for a structure which allows the skive blade to be replaced in the cleaner assembly. The invention described below addresses this need and provides a unique structure where the skive blade can be replaced in the field. This reduces maintenance costs by replacing an individual components within an assembly instead of having to replace the entire assembly.

### SUMMARY OF THE INVENTION

In view of the foregoing and other problems, disadvantages, and drawbacks of the conventional cleaner assembly the present invention has been devised, and it is an object of the present invention to provide a structure and method for an improved cleaner assembly.

In order to attain the object(s) suggested above, there is provided, according to one aspect of the invention having a cleaner assembly for a roller in an imaging apparatus, the cleaner assembly is a skive blade in contact with the roller and a slot formed by a casing of the cleaner assembly. This includes the slot that holds the skive blade and allows the skive blade to be selectively mounted on and removed from the cleaner assembly. The cleaner assembly includes the slot having a “C” shape in cross-section and further has a biasing rib on the casing adjacent the slot including the biasing rib biases the skive blade toward the roller. The skive blade includes a bend causing one end of the skive blade to extend toward the roller. Further is a seal blade extending from the cartridge that includes the seal blade provides dusting containment for waste particles removed by the skive blade and a rod within the casing adapted to support the seal blade and to provide stiffness to the cleaner assembly and further includes the cartridge having an insulator.

The invention also comprise a method of cleaning a roller in an imaging apparatus. The steps of providing a cleaner assembly with a skive blade in contact with the roller and forming a slot in a casing of the cleaner assembly holding the skive blade within the slot such that the skive blade can be selectively mounted on and removed from the cleaner assembly. The cleaner assembly has the slot having a “C” shape in cross-section and further is biasing rib on the casing adjacent the slot including the biasing rib biases the skive blade toward the roller. The cleaner assembly having the skive blade includes a bend causing one end of the skive blade to extend toward the roller. The cleaner assembly further includes a seal blade extending from the cartridge, wherein the seal blade provides dusting containment for waste particles removed by the skive blade and has a rod within the casing adapted to support the seal blade and to provide stiffness to the cleaner assembly that includes the cartridge having an insulator.

One problem with conventional cleaner assemblies is that the skive blade is subjected to high levels of wear and is commonly the first component to degrade below an acceptable level, which may require premature cleaner assembly replacement. In conventional structures, the skive blade is an integral part of the cleaner assembly and is not removable therefrom, or removal of the skive blade requires specialized tools and skills not available to the customer. Therefore, if the skive blade suffers excessive wear in a conventional cleaner assembly, the entire cleaner assembly must be (prematurely) replaced, or service must be contacted for a specially trained person to effect the change of the skive blade. This may cause unnecessary disposal of many properly functioning parts within the cleaner assembly, service costs and downtime, simply because the skive blade has suffered excessive wear. The invention overcomes this problem by providing a skive blade which is independently replaceable.

### BRIEF DESCRIPTION OF THE DRAWINGS

The foregoing and other objects, aspects and advantages will be better understood from the following detailed description of a preferred embodiment(s) of the invention with reference to the drawings, in which:

FIGS. 1A and 1B are side elevation schematics of a color printer apparatus utilizing a cleaning apparatus of the invention.

FIG. 2 is a side elevation schematic showing in greater detail the cleaning apparatus forming a part of the apparatus of FIG. 1.

FIG. 3 is a side elevation schematic showing in greater detail the cleaning apparatus and detachable skive blade forming a part of the apparatus of FIG. 2.

### DETAILED DESCRIPTION OF PREFERRED EMBODIMENTS OF THE INVENTION

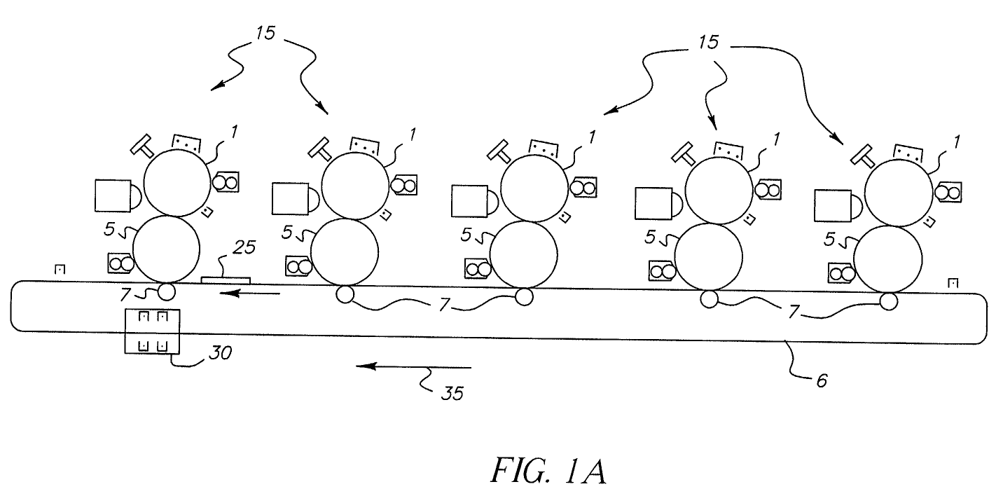

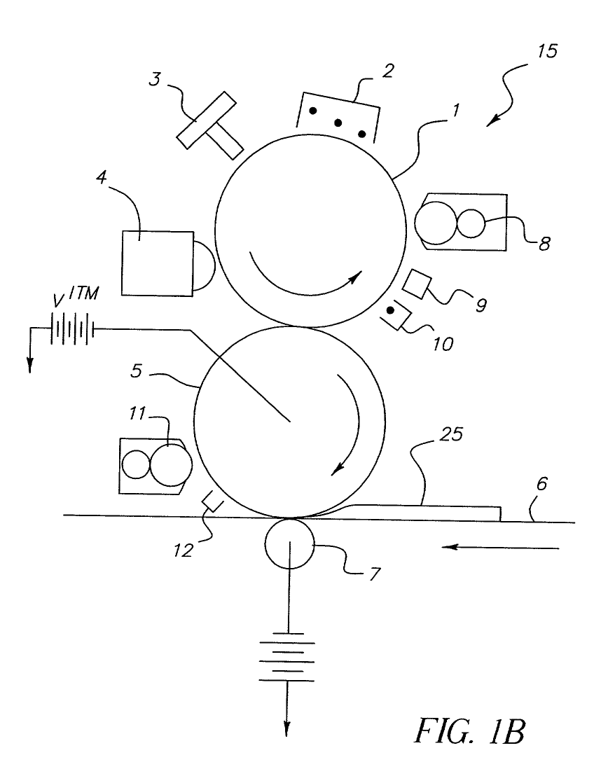

FIG. 1A illustrates an apparatus in which the invention may be used. A conveyer 6 is drivable to move a receiving sheet 25 (e.g., paper, plastic, etc.) past a series of stations 15. One of the stations 15 is shown in greater detail in FIG. 1B.

With the invention, a primary image member (for example a photoconductive drum) 1 within each imaging station 15 is initially charged by a primary charging station 2. This charge is then modified by a printhead 3 (e.g., LED printhead) to create an electrostatic image on the primary image member 1. A development station 4 deposits toner on the primary image member 1, to form a toner image corresponding to the color of toner in each individual imaging station 15. The toner image is electrostatically transferred from the primary image member 1 to an intermediate transfer member, for example, intermediate transfer roller or drum 5. While both the primary image member 1 and the intermediate transfer drum 5 are shown as drums, as would be known by one ordinarily skilled in the art, these could also comprise belts or similar image transfer surfaces. The primary image member 1 and the intermediate transfer drum 5 used in these examples are rollers or drums to simplify the explanation of the invention; However, the invention is not limited to drums, but instead is applicable to all similar structures/surfaces.

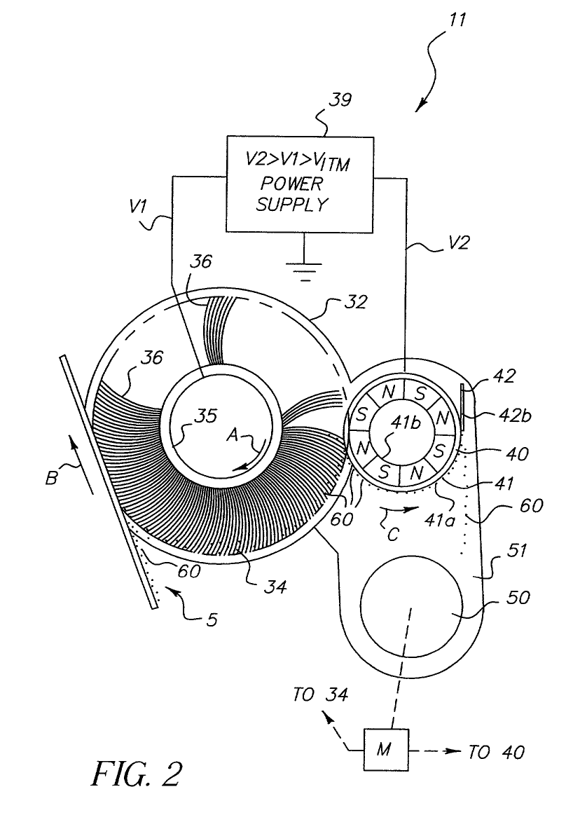

After the charged toner is transferred to the intermediate transfer drum 5, there still remains some waste toner particles that need to be removed from the primary image member 1. The invention uses a pre-cleaning erase light emitting diode (LED) lamp 9 in combination with pre-cleaning charging station 10 in order to electrostatically modify the surface potential of the non-image areas of the primary image member 1 and the charge on the waste toner remaining on the primary image member 1, respectively. In addition, a cleaning station 8 is included to physically remove any remaining waste toner particles. The cleaning station 8 is illustrated in FIG. 2 and discussed in greater detail below.

A transfer nip is used between a transfer backer roller 7 and the intermediate transfer drum 5 to transfer the toner image to the receiving sheet 25. In a similar manner to that discussed above, the remaining waste toner particles that remain on the intermediate transfer drum 5 after the toner has been transferred to the sheet 25, are removed using a pre-cleaning charging station 12 and a cleaning station 11. Once again, the details of the cleaning station 11 are shown in FIG. 2 and are discussed below in detail. The receiving sheet 25 is transported by a dielectric conveyor 6 to a fuser 30 where the toner image is fixed by conventional means. The receiving sheet is then conveyed from the fuser 30 to an output tray 35.

The toner image is transferred from the primary image member 1 to the intermediate transfer drum 5 in response to an electric field applied between the core of drum 5 and a conductive electrode forming a part of primary image member 1. The toner image is transferred to the receiving sheet 25 at the nip in response to an electric field created between the backing roller 7 and the transfer drum 5. Thus, transfer drum 5 helps establish both electric fields. As is known in the art, a polyurethane roller containing an appropriate amount of anti-static material to make it of at least intermediate electrical conductivity can be used for establishing both fields. Typically, the polyurethane or other elastomer is a relatively thick layer; e.g. one-quarter inch thick, which has been formed on an aluminum base.

Preferably, the electrode buried in the primary image member 1 is grounded for convenience in cooperating with the other stations in forming the electrostatic and toner images. If the toner is a positively-charged toner, an electrical bias V_{ITM} applied to intermediate transfer drum 5 of typically −300 to −1,500 volts will effect substantial transfer of toner images to the transfer drum 5. To then transfer the toner image onto a receiving sheet 25, a bias, e.g., of −2,000 volts or greater negative voltages is applied to backing roller 7 to again urge the positively charged toner to transfer to the receiving sheet. Schemes are also known in the art for changing the bias on drum 5 between the two transfer locations so that roller 7 need not be at such a high potential.

The ITM or drum 5 has a polyurethane base layer upon which a thin skin is coated or otherwise formed having the desired release characteristics. The polyurethane base layer preferably is supported upon an aluminum core. The thin skin may be a thermoplastic and should be relatively hard, preferably having a Young's modulus in excess of 5*10⁷ Newtons per square meter to facilitate release of the toner to ordinary paper or another type of receiving sheet. The base layer is preferably compliant and has a Young's modulus of 10⁷ Newtons per square meter or less to assure good compliance for each transfer.

With reference also now to FIG. 2, the cleaning apparatus 11 comprises a housing 32 which encloses the cleaning brush 34 having conductive fibers (fur) 36 which, through an opening in the housing, engage the intermediate transfer drum 5.

The brush 34 is supported on a core 35 which is driven in rotation by a motor M or other motive source to rotate in the direction of the arrow A as the ITM is moved in the direction shown by arrow B. As the brush rotates, untransferred toner particles 60 and other particulate debris, such as carrier particles and paper dust, on the intermediate transfer drum 5 are mechanically scrubbed from the intermediate transfer drum 5 and picked up into the fibers 36 of the brush. The items illustrated in the figures are generally not shown to scale to facilitate understanding of the structure and operation of the apparatus. In particular, the brush fibers are shown much larger to scale than other structures shown in FIG. 2.

In addition to mechanical scrubbing, an electrical bias is applied to the cleaning brush from power supply 39. The electrical bias V1 of the power supply 39 to the cleaning brush is, as will be more fully explained below, inductively, and not conductively, coupled to the conductive fibers or brush fibers 36. The voltage V1 is greater than the voltage bias V_{ITM} applied to the intermediate transfer drum 5. The polarity of the voltage on the brush fibers is such as to electrostatically attract toner 60 to the brush fibers. The toner particles 60 entrained within the fibers are carried to a rotating detoning roller 40 which is electrically biased by power supply 39 to a higher voltage level V2 than the voltage level V1; i.e., the voltage level V2 is of a level to electrostatically attract the toner particles in the brush to the detoning roller. Assuming a positively charged toner image, as an example, the toner image may be attracted to the intermediate transfer drum 5 which is biased to the voltage bias V_{ITM} in the range of about −300 volts to about −1500 volts. The cleaning brush, in such an example would be biased to a potential V1 which is in the range of about −550 volts to about −1750 volts. The detoning roller in this example would be biased to a potential V2 which is in the range of about −800 volts to about −2000 volts. In considering relationships of voltage V2>V1>V_{ITM}, the absolute values of the voltages are implied.

The toner particles 60 are electrostatically attracted to the surface 41 of the detoning roller 40. The surface of detoning roller 40 is rotated in the direction of arrow C by a drive from motor M counter to that of the brush fibers or alternatively in the same direction. The toner particles are carried by the surface 41 of the detoning roller towards a stationary skive blade 42 which is supported as a cantilever at end 42a so that the scraping end 42b of the blade 42 engages the surface 41 of the detoning roller.

Toner particles scrubbed from the surface are allowed to fall into a collection chamber 51 of housing 32 and periodically a drive such as from motor M or other motive source is provided to cause an auger 50 or other toner transport device to feed the toner to a waste receptacle. Alternatively, the collection receptacle may be provided attached to housing 32 so that particles fall into the receptacle directly and the auger may be eliminated. In order to ensure intimate contact between the detoning roller surface 41 and the skive blade 42, a permanent magnet is stationarily supported within the hollow enclosure of the detoning roller. The skive blade is made of a metal such as ferromagnetic steel and is of thickness of less than 0.5 mm and is magnetically attracted by the magnet to the detoning roller surface 41. This effectively minimizes the tendency of the blades end 42b to chatter as the surface 41 travels past the blade end 42b and thus provides more reliable skiving of the toner and therefore improved image reproduction. The skive blade extends for the full working width of the detoning roller surface 41.

The detoning roller 40 preferably comprises a toning or development roller as used in known SPD-type development stations which includes a core of permanent magnets surrounded by a metal sleeve 41a. As a detoning roller, the magnetic core is formed of a series of alternately arranged poles (north-south-north-south, etc.) permanent magnets 41b that are stationary when in operation. Sleeve 41a is formed of polished aluminum or stainless steel and is electrically conductive but nonmagnetic so as not to reduce the magnetic attraction of the skive blade to the magnets in the core. The sleeve is driven in rotation in the direction of arrow C and is electrically connected to potential V2.

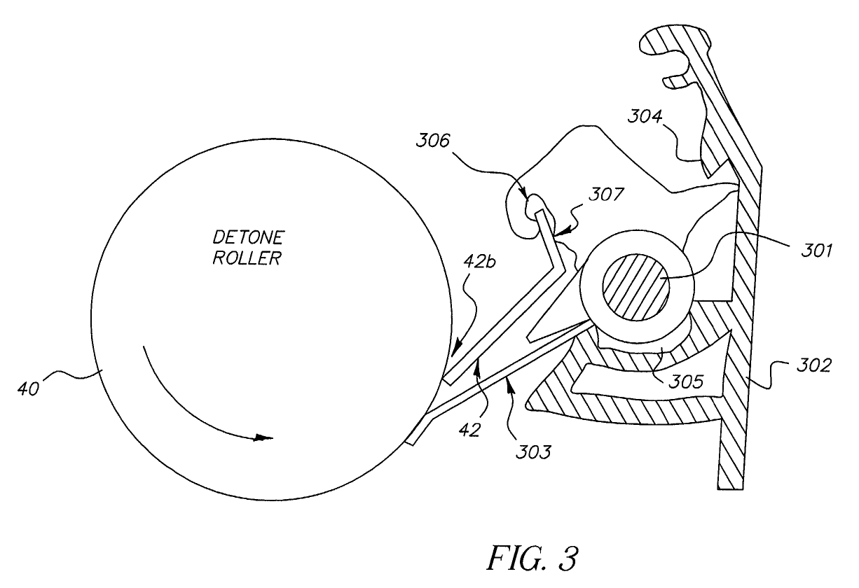

The schematic diagram shown in FIG. 2 is a conceptual diagram to illustrate the function of the skive 42 against the detone roller 40. FIG. 3 illustrates a more accurate schematic drawing of an actual cleaner assembly casing or cartridge 300 that would be used in practice. The cartridge assembly 300 includes a skive 42 that makes contact with the detone roller 40 to remove waste toner and waste particles, as described above. The cleaner assembly is made of a hard durable material such as plastic and is supported within the imaging device frame 302 by support brackets 304, 305. The cartridge assembly 300 shown in FIG. 3, includes a plastic seal blade 303 that is adhesively affixed to the cartridge assembly 300. The geometry and orientation of the cartridge assembly 300 biases the detone blade 42 against the detone roller 40. The rod 301 preferably comprises a stiff member (e.g., steel, etc.) and is molded in the center of the cartridge assembly 300 to maintain the necessary stiffness and straightness of the cartridge assembly 300 for proper function.

The seal blade 303 remains in constant contact with the detone roller 40 and prevents the formation of a dust cloud created as waste particles are removed by the skive 42. The plastic seal blade 303 thus provides dust containment at the point of blade contact with the rotating detone roller. The skive blade 42 can be metallic or insulating

The exterior of the cartridge assembly 300 is designed to match the support brackets 304, 305 such that the entire assembly 300 can be slid out of the imaging device frame 302 and replaced when necessary. More specifically, FIG. 3 is a cross-sectional two-dimensional (x, y) diagram. The cleaner assembly 300 is removed from the support brackets 304, 305 by sliding the cleaner assembly 300 along the surfaces of the support brackets 304, 305 until the cleaner assembly 300 is free of the support brackets 304, 305. In other words, the cleaner assembly 300 would be slid in a three-dimensional space in a direction coming out of the page (the Z direction). By using such support brackets 304, 305, the cleaner assembly is easily replaced by the user without requiring tools. The support brackets 304, 305 and the matching shape of the cleaner assembly casing 300 can take on many forms and the invention is not limited to the specific shape shown in FIG. 3. To the contrary, as would be known by one ordinarily skilled in the art, the support brackets 304, 305 can take on almost any shape so long as the shapes coordinate to hold the cartridge assembly 300 in place, yet still allow the cleaner assembly to be easily slid out of the imaging device.

As discussed above, one problem with conventional cleaner assemblies is that the skive blade is subjected to high levels of wear and is commonly the first component to degrade below an acceptable level, which may require premature cleaner assembly replacement. In conventional structures, the skive blade is an integral part of the cleaner assembly and is not removable therefrom, or removal of the skive blade requires specialized tools and skills not available to the customer. Therefore, if the skive blade suffers excessive wear in a conventional cleaner assembly, the entire cleaner assembly must be (prematurely) replaced, or service must be contacted for a specially trained person to effect the change of the skive blade. This may cause unnecessary disposal of many properly functioning parts within the cleaner assembly, service costs and downtime, simply because the skive blade has suffered excessive wear. The invention overcomes this problem by providing a skive blade 42 which is replaceable.

More specifically, the cartridge assembly casing 300 includes a skive mount slot 306 for the skive blade 42. In a preferred embodiment, the skive mount 306 has a “C” shape in cross section. In the example shown in FIG. 3, the skive blade 42 includes a bend that allows the skive blade edge 42b to contact the detone roller 40. In addition, the cleaner assembly 300 includes a biasing rib 307 below the slide mount slot 306 that biases the skive blade 42 in a direction toward the detone roller 40 and maintains the skive blade 42 securely within the slide mount slot 306.

With the invention, a used skive blade 42 can be slid in a direction out of the page (the Z direction) to be removed from the cartridge assembly casing 300 and replaced with a new skive blade.

The skive blade 42 slides into the extruded “C” shaped channel on the cartridge assembly casing 300 and precisely positions the blade against the detone roller 40 with no further adjustment or touching of the blade required. Replacement of the blade is rapid and accuracy of positioning within required specifications is assured. As the blade becomes biased to high voltage during the imaging device operation, the material (e.g., plastic, etc.) from which the cartridge assembly casing is manufactured provides electrical isolation from the grounded frame 302.

Thus, the invention permits the exchange of the skive blade by persons with minimal training, without damage to the blade by providing a slide-in feature that does not require the operator to touch the blade or make position adjustments. The invention provides mounting, positioning, electrical isolation, and an installation guide/aid for a skive blade used within an electrostatic brush cleaner device, used for removing residual material from imaging surfaces within an electrostatic printing device. The blade is thus located to a high degree of accuracy against the detone roller.

While the invention has been described in terms of preferred embodiments, those skilled in the art will recognize that the invention can be practiced with modification within the spirit and scope of the appended claims.

PARTS LIST

| Item | Description |
|---|---|
| 1 | image member |
| 2 | imaging charging station |
| 3 | printhead |
| 4 | development station |
| 5 | intermediate transfer drum |
| 6 | conveyer |
| 7 | transfer backer roller |
| 8 | cleaning station |
| 9 | LED lamp |
| 10 | pre-cleaning charging station |
| 11 | cleaning station |
| 12 | pre-cleaning charging station |
| 15 | station |
| 25 | receiving sheet |
| 30 | fuser |
| 32 | casing/housing |
| 34 | cleaning brush |
| 35 | output tray |
| 36 | fibers |
| 39 | power supply |
| 40 | detoning roller |
| 41 | surface |
| 41a | sleeve |
| 41b | permanent magnets |
| 42 | skive blade |
| 42a | blade end |
| 42b | scraping blade end |
| 42c | blade ears |
| 50 | auger |
| 51 | collection chamber |
| 60 | toner particles |
| 300 | cartridge assembly |
| 301 | rod |
| 302 | imaging device frame |
| 303 | seal blade |
| 304 | support bracket |
| 305 | support bracket |
| 306 | slide mount slot |

What is claimed is:

1. A cleaner assembly for a roller in an imaging apparatus, said cleaner assembly comprising:
a skive blade in contact with said roller; and
a slot formed by a casing of said cleaner assembly,
wherein said slot holds said skive blade and allows said skive blade to be selectively mounted on and removed from said cleaner assembly.

2. The cleaner assembly in claim 1, wherein said slot comprises a “C” shape in cross-section.

3. The cleaner assembly in claim 1, further comprising biasing rib on said casing adjacent said slot, wherein said biasing rib biases said skive blade toward said roller.

4. The cleaner assembly in claim 1, wherein said skive blade includes a bend causing one end of said skive blade to extend toward said roller.

5. The cleaner assembly in claim 1, further comprising a seal blade extending from said cartridge, wherein said seal blade provides dusting containment for waste particles removed by said skive blade.

6. The cleaner assembly in claim 5, further comprising a rod within said casing adapted to support said seal blade and to provide stiffness to said cleaner assembly.

7. The cleaner assembly in claim 1, wherein said cartridge comprises an insulator.

8. A cleaner assembly for a roller in an imaging apparatus, said cleaner assembly comprising:
a skive blade in contact with said roller;
a slot formed by a casing of said cleaner assembly, wherein said slot holds said skive blade and allows said skive blade to be selectively mounted on and removed from said cleaner assembly; and a biasing rib on said casing adjacent said slot, wherein said biasing rib biases said skive blade toward said roller.

9. The cleaner assembly in claim 8, wherein said slot comprises a “C” shape in cross-section.

10. The cleaner assembly in claim 8, wherein said skive blade includes a bend causing one end of said skive blade to extend toward said roller.

11. The cleaner assembly in claim 8, further comprising a seal blade extending from said cartridge, wherein said seal blade provides dusting containment for waste particles removed by said skive blade.

12. The cleaner assembly in claim 12, further comprising a rod within said casing adapted to support said seal blade and to provide stiffness to said cleaner assembly.

13. A method of cleaning a roller in an imaging apparatus comprising the steps of:
providing a cleaner assembly with a skive blade in contact with said roller; and
forming a slot in a casing of said cleaner assembly,
holding said skive blade within said slot such that said skive blade can be selectively mounted on and removed from said cleaner assembly.

14. The method in claim 13, wherein said slot comprises a “C” shape in cross-section.

15. The method in claim 14, further comprising providing a biasing rib on said casing adjacent said slot, wherein said biasing rib biases said skive blade toward said roller.

16. The method in claim 14, further comprising forming said skive blade to include a bend causing one end of said skive blade to extend toward said roller.

17. The method in claim 14, further comprising providing a seal blade extending from said cartridge, wherein said seal blade provides dusting containment for waste particles removed by said skive blade.

18. The method in claim 18, further comprising providing a rod within said casing, wherein said rod is adapted to support said seal blade and to provide stiffness to said cleaner assembly.

19. The method in claim 14, wherein said cartridge comprises an insulator.

20. A method of cleaning a roller in an imaging apparatus comprising the steps of:
providing a cleaner assembly with a skive blade in contact with said roller;
forming a slot in a casing of said cleaner assembly,
holding said skive blade within said slot such that said skive blade can be selectively mounted on and removed from said cleaner assembly; and providing a biasing rib on said casing adjacent said slot, wherein said biasing rib biases said skive blade toward said roller.

21. The method in claim 20, wherein said slot comprises a “C” shape in cross-section.

22. The method in claim 20, further comprises forming said skive blade to include a bend causing one end of said skive blade to extend toward said roller.

23. The method in claim 20, further comprising providing a seal blade extending from said cartridge, wherein said seal blade provides dusting containment for waste particles removed by said skive blade.

24. The method in claim 23, further comprising providing a rod within said casing, wherein said rod is adapted to support said seal blade and to provide stiffness to said cleaner assembly.

25. The method in claim 20, wherein said cartridge comprises an insulator.
